(19) United States
(12) Patent Application Publication
(10) Pub. No.: US 2026/0307715 A1
(43) Pub. Date: Oct. 8, 2026

(54) Method for Generating Roadway Feedback for a Steer-By-Wire Steering System for a Vehicle Driver, and a Steer-By-Wire Steering System

(71) Applicant: BAYERISCHE MOTOREN WERKE AKTIENGESELLSCHAFT, München (DE)

(72) Inventors: Marius CAESAR, Theiheim (DE); Matthias SCHOELZEL, Muenchen (DE)

(21) Appl. No.: 19/483,270

(22) PCT Filed: Apr. 11, 2024
(86) PCT No.: PCT/DE2024/100302

§ 371 Date: Nov. 11, 2025

(30) Foreign Application Priority Data
May 12, 2023 (DE) 102023112568.0

(51) Int. Cl. B62D 6/00

(52) U.S. Cl. CPC B62D 6/008

(57) ABSTRACT

A method for generating roadway feedback of roadway excitations of a steer-by-wire steering system for a vehicle driver includes calculating a lateral acceleration and/or a rolling movement of the vehicle, and comparing the calculated lateral acceleration and/or rolling movement with measured sensor signals of the lateral acceleration and/or rolling movement. When the calculated difference exceeds a threshold value, a haptic roadway feedback is generated at a steering controller actuator of the steer-by-wire steering system.

### BACKGROUND AND SUMMARY

The invention relates to a method for generating roadway feedback of a steer-by-wire steering system for a vehicle driver and a steer-by-wire steering system.

So-called steer-by-wire steering systems of vehicles are already known in various forms from the prior art. Such a steering system differs from conventional steering systems in that the steering of the wheels is fully uncoupled from the mechanical steering motion of the driver or takes place only via purely electronic transmission. The conventional mechanical transmission devices are omitted; instead, the driver generates data via a steering motion at the so-called steering handle or at the steering wheel, which data are fed to an electronic control unit. This control unit evaluates the data and converts it into corresponding steering commands. This activates the steering gear, which executes the desired steering motion.

To impart a corresponding steering feel to the vehicle driver with a steer-by-wire steering system in the way that they are accustomed to with conventional steering systems, a steering wheel actuator or an actuation-force simulator or a steering wheel motor or a feedback actuator is commonly arranged on the steering wheel module. In accordance with the available sensor data, control electronics calculate a control value for the feedback actuator, which consequently produces a steering wheel resistance at the steering wheel. This steering wheel resistance should ideally reproduce the frictional relationships between the tires and the roadway at the appropriate level.

Such a steer-by-wire steering system is demonstrated in DE 10 2014 211 815 A1.

An object of the invention is to demonstrate systems and methods for operating a steer-by-wire steering system, which delivers authentic roadway feedback to the vehicle driver.

At least this object is achieved by the features of the embodiments disclosed herein.

A method for generating roadway feedback of roadway excitations of a steer-by-wire steering system for a vehicle driver is proposed.

In this, a lateral acceleration or roll motion of the vehicle is calculated. The calculation of this lateral acceleration or roll motion preferably takes place here using a model-based calculation method, for example using a so-called single-track model or roll model.

It is furthermore proposed that the calculated lateral acceleration and/or roll motion is compared with measured sensor signals relating to a lateral acceleration and/or a roll motion of the vehicle (also referred to as measured lateral acceleration or roll motion) and the difference between them is calculated. In other words, the calculated lateral acceleration or roll motion is compared with a measured lateral acceleration or roll motion and the difference between them is calculated.

If the ascertained difference exceeds a threshold value or a predefined threshold, haptic roadway feedback is generated at a steering handle actuator (preferably a steering wheel actuator) of the steer-by-wire steering system.

If the threshold value is exceeded, a steering handle torque or a steering wheel torque is preferably transmitted to the steering handle actuator or the steering wheel actuator in dependence on a steering rack force applied at the steering rack of the steering system and haptic feedback is therefore provided for the vehicle driver at a steering handle of the vehicle.

In addition to the applied steering rack force, the calculated lateral acceleration and the calculated roll of the vehicle are then indicators that a roadway excitation is present.

If said threshold value of the difference between the calculated and the measured signal is exceeded, this indicates a lateral acceleration or roll motion of the vehicle which goes beyond or deviates from a steering motion. It is therefore indicated that the lateral acceleration or the roll motion of the vehicle should be attributed to a roadway excitation.

If the threshold value is exceeded, this gives an indication that the vehicle is experiencing lateral acceleration or roll which is independent of the steering motion of the vehicle and is instead caused by roadway conditions.

This should be reported to a vehicle driver via haptic feedback, preferably at the steering handle.

Detection, analysis and implementation methods may therefore be advantageously demonstrated, whereby reliable and authentic haptic feedback to a vehicle occupant takes place in the event of a roadway excitation.

It is furthermore preferably provided that the roll motion of the vehicle is calculated as a roll rate.

The roll motion, in particular the roll rate, is preferably calculated using a calculation model, for example a roll model, and then compared with a roll motion signal, in particular a roll rate signal, of a sensor in the vehicle, which signal is measured in the center of gravity of the vehicle. To calculate the roll rate, it is possible to use, for example, an angle produced by the difference between the level of the axle of the vehicle, in particular the front axle of the vehicle, on the left side and on the right side. The roll rate may be calculated from the derivative of this angle.

A single-track model, for example, may be used in the calculation of the lateral acceleration of the vehicle. The lateral acceleration here is calculated in dependence on a current steering rack force applied at a steering rack of the steering system. This calculated lateral acceleration is then compared with measured sensor signals relating to the lateral acceleration of the vehicle.

A steer-by-wire steering system (steering system for short) according to the co-ordinate claim 7 is furthermore proposed.

The steering system comprises at least one calculator unit for calculating a lateral acceleration and/or a roll motion of the vehicle. The level sensors on a right and left wheel or wheel suspension serve to calculate the lateral acceleration, for example. A roll motion may be calculated from the difference in level, using the derivative of the resultant angle.

Furthermore, the steering system comprises at least one sensor unit for measuring at least a lateral acceleration and/or roll motion of the vehicle. A sensor in the center of gravity of the vehicle may be used, for example, to measure the roll rate.

The steering system furthermore comprises at least one evaluation unit for comparing the calculated and the measured lateral acceleration and/or roll motion of the vehicle.

Moreover, the steering system comprises a steering handle actuator which can be activated by a control unit and which is designed to generate synthetic, haptic roadway feedbacks for a vehicle driver in response to the comparison.

These and further features are revealed not only in the claims and in the description, but also in the drawings, in which individual features are realized either alone or in sub-combinations as an embodiment of the invention and may represent advantageous embodiments which are patentable in their own right and for which protection is claimed here.

The various features of one or more embodiments are further explained below with reference to the figures.

### BRIEF DESCRIPTION OF THE DRAWINGS

In FIG. 1, shows a schematic depiction of a vehicle that experiences a roll motion.

FIGS. 2 and 3 each show an exemplary curve of a calculated and a measured roll rate.

### DETAILED DESCRIPTION OF THE DRAWINGS

FIG. 1 shows a schematic depiction of a vehicle in a front view, which vehicle experiences a roll motion W about its longitudinal axis as a result of a spring motion of the vehicle suspension F. Level sensors are arranged on the respective vehicle suspension F at the two wheels R of the front axle of the vehicle and may be used to measure the exact height h_{FR}, h_{FL} of the wheel suspension or wheel housing at a respective wheel.

Provision is now made to calculate the roll rate \dot{θ}₂ using the roll model depicted in FIG. 1. The roll rate \dot{θ}₁ measured in the center of gravity SP shall then be compared with the calculated roll rate. If the difference between these two values exceeds a certain specified threshold value, it may be assumed that the roll motion of the vehicle has occurred due to a roadway unevenness.

Roadway feedback in the form of a steering handle torque is generated for the vehicle driver at the steering handle in dependence on the steering rack force F_{Z} applied to the steering rack of the vehicle at this point in time.

In this specific case, the roll rate \dot{θ}₂ is calculated using the derivative of the difference between the two heights h_{FR}, h_{FL} from the level sensors on the front axle and the resultant angle θ₂.

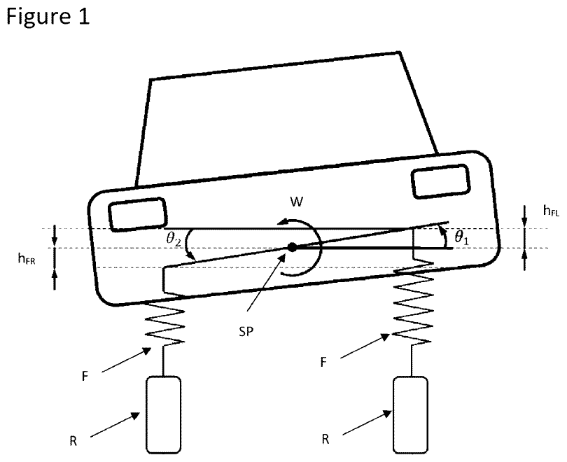

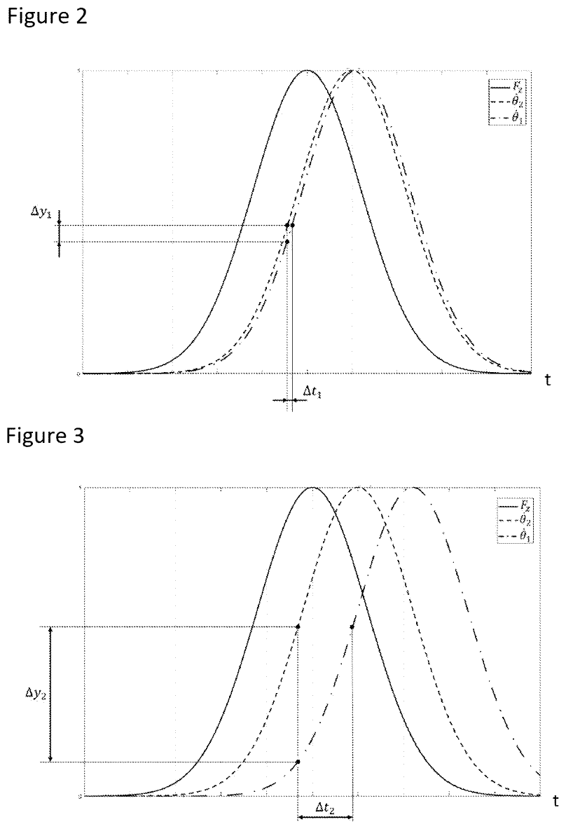

In FIG. 2 and FIG. 3, the measured roll rate \dot{θ}₁ and the calculated roll rate \dot{θ}₂ are shown over time t and the steering rack force F_{Z} is shown over time t. FIG. 2 demonstrates the roll behavior during a steering intervention, whereas the roll behavior demonstrated in FIG. 3 is triggered by a roadway unevenness.

As can be seen in FIG. 2 and FIG. 3, temporally speaking, the steering rack force F_{Z} acts or is produced first in each case. A steering rack force F_{Z} is produced with each roll motion (regardless of whether this is caused by a steering intervention or by a roadway unevenness). However, if the steering rack force F_{Z} is caused by a steering intervention, this is not reported to the vehicle driver in the form of a steering handle torque. Conversely, if the steering rack force F_{Z} is caused by a roadway unevenness, provision is made for the driver to receive haptic feedback relating to this in the form of a steering handle torque. The offset between the respective roll rates \dot{θ}₂ and \dot{θ}₁ is shown merely by way of example and schematically in the figures and may deviate from the offset shown.

As can be seen in FIG. 2, in the case of a roll motion of the vehicle which is caused by a steering motion of the vehicle, the signal curve, and therefore the difference between the measured and calculated roll rates Δy₁ and also the time lag Δt₁, is small. By way of example, when driving over a rut (i.e. a roadway excitation), the wheel contact point of the vehicle shifts, whereby the vehicle deflects and rebounds. This reaction can be promptly detected by the level sensors and, as can be seen in FIG. 3, results in a greater time lag Δt₂ and a greater difference Δy₂ compared to the measured roll rate \dot{θ}₁ in the vehicle center of gravity SP (c.f. Δy₁ and Δt₂ shown in FIG. 2).

In the event of a normal deflection, a harmonic roll behavior can therefore be seen according to FIG. 2, i.e. the wheel spring travel (for example measured at the level sensors) and the measured roll behavior in the center of gravity SP are temporally very close to one another. If a steering rack motion is caused by roadway unevennesses, there is a significant temporal offset between the calculated roll rate \dot{θ}₂ and the actually measured roll rate \dot{θ}₁.

Therefore if a certain time lag Δt₂ or roll difference Δy₂ is exceeded, this gives an indication that a roadway excitation is responsible for the vehicle roll. This is reported haptically to a vehicle driver in the form of a steering handle torque in dependence on the current steering rack force F_{Z}. The driver thus advantageously receives authentic feedback relating to the roadway conditions.

1-7. (canceled)

8. A method for generating roadway feedback of roadway excitations of a steer-by-wire steering system for a vehicle driver, comprising:
calculating a lateral acceleration and/or a roll motion of the vehicle;
determining a difference between the calculated lateral acceleration and/or roll motion and measured sensor signals relating to the lateral acceleration and/or roll motion;
when the calculated difference exceeds a threshold value, generate haptic roadway feedback at a steering handle actuator of the steer-by-wire steering system.

9. The method of claim 8, wherein the roll motion is calculated and measured as the roll rate.

10. The method of claim 9, wherein the calculated roll rate is calculated from the derivative of an angle that is the result of the difference between a level sensor on the left of an axle and a level sensor on the right of an axle.

11. The method of claim 8, wherein the roll motion of the vehicle is calculated using a calculation model and is compared with a roll motion signal of a sensor in the vehicle measured in the center of gravity of the vehicle.

12. The method of claim 11, wherein the calculated roll rate is calculated from the derivative of an angle that is the result of the difference between a level sensor on the left of an axle and a level sensor on the right of an axle.

13. The method of claim 8,
wherein the lateral acceleration of the vehicle is calculated using a single-track model in dependence on a current steering rack force applied to a steering rack of the steering system, and
wherein the calculated lateral acceleration is compared with measured sensor signals relating to the lateral acceleration of the vehicle.

14. The method of claim 8, wherein:
when the threshold value is exceeded, a torque of a steering handle of the steer-by-wire steering system is switched to the steering handle actuator in dependence on a currently applied steering rack force.

15. A steer-by-wire steering system of a vehicle, comprising
at least one calculation unit configured to calculate a lateral acceleration and/or a roll motion of the vehicle;
at least one sensor unit configured to measure at least a lateral acceleration and/or roll motion of the vehicle;
at least one evaluation unit configured to compare the calculated and the measured lateral acceleration and/or roll motion of the vehicle; and
a steering handle actuator that is activatable by a control and is configured to generate synthetic, haptic roadway feedbacks to a vehicle driver in response to the comparison.
